(19) United States
(12) Patent Application Publication
(10) Pub. No.: US 2021/0069531 A1
(43) Pub. Date: Mar. 11, 2021

(54) QUICK RELEASE AUTO-BLOCKING BELAY DEVICE

(71) Applicant: HIGHNOVATE, Kiryat Tivon (IL)

(72) Inventor: Beeri Berl KATZNELSON, Kiryat Tivon (IL)

(73) Assignee: HIGHNOVATE, Kiryat Tivon (IL)

(21) Appl. No.: 16/477,210

(22) PCT Filed: Jan. 11, 2018
(86) PCT No.: PCT/IL2018/050045

§ 371 Date: Jul. 11, 2019

(30) Foreign Application Priority Data
Jan. 12, 2017 (IL) 250095

(51) Int. Cl. A62B 1/14; A63B 29/02

(52) U.S. Cl. CPC A62B 1/14; A63B 29/02

(57) ABSTRACT

A quick release auto-blocking belay device for abseiling that includes a main body and a removable locking mechanism. The main body has a front and back walls, a compartment between them and a connecting hole for connecting the device to a carabiner. The front and the back walls include an entry and an exit holes. The removable locking mechanism includes a ball lock pin, a cam rotating piece, a fixing disk and a releasing lever.

### TECHNICAL FIELD

The present invention relates to a quick release auto-blocking belay device.

### SUMMARY OF THE INVENTION

A quick release auto-blocking belay device is disclosed comprising a main body, a rope control assembly, a rope control handle and a load hanging means. The rope control assembly may comprise an external unit, a disk element, a shaft and a cam-like inner part, wherein the external unit, the disk element, the cam-like inner part and the shaft are connected together to rotate as one piece. According to some embodiments the rope control assembly is adapted to fit into a first hole made in a first wall of the main body and into a second hole made in a second wall of the main body, to be locked after insertion and to rotate about a common axis passing longitudinally through the shaft.

In some embodiments, the rope control assembly is adapted be locked in the main body or to be released from the main body by pressing a release knob.

In some embodiments, the cam-like inner part is adapted to provide auto blocking force onto a rope threaded through the main body and around the cam-like inner part, when no manual rotation force is provided to the rope control assembly.

A method of operating a quick release auto-blocking belay device comprising providing a quick release auto-blocking belay device, pressing a release knob on a shaft of the quick release auto-blocking belay device, pulling the rope control assembly out from the main body of the pulling the rope control assembly out from the main body, inserting the rope control assembly into the main body, and locking the rope control assembly by releasing the knob.

In some embodiments the method further comprising, when finishing use of the quick release auto-blocking belay device, pressing the release knob on the shaft, pulling the rope control assembly out from the main body and inserting the rope control assembly into the main body.

In some embodiments the use of the auto-blocking belay device further comprise controlling the speed of threading of the rope through the main body by changing the relative rotation angle of the rope control assembly with respect to the main body, by means of rotating the rope control handle.

In some embodiments the method further comprise, during the use of the auto-blocking belay device, allowing the cam-like inner part to lock the rope in the main body and prevent it from being pulled out, when the rope control handle is not set to enable threading of the rope through the main body.

### BACKGROUND

The basic equipment for abseiling includes a climbing harness (100), a standard belay device (200) and a carabiner (300) and a rope (400) as depicts in FIG. 1. The user who abseils down wears the harnesses to which the carabiner and the belay device are connected. Usually, the belay device can be designed for two ropes or one. Then the user inserts the rope, in a loop manner, through the belay device and connects the rope to the carabiner. After that, the user abseils down and he can control the descending by releasing and locking the rope on the belay device.

When the user arrives down he needs to disconnect the rope from the carabiner, an action which takes several seconds. In pleasure activities these several seconds have no importance, but in times of emergency and for law enforcement and military units these seconds are a matter and the present invention discloses an innovative belay device to solve this problem and others.

### BRIEF DESCRIPTION OF THE DRAWINGS

The intention of the drawings attached to the application is not to limit the scope of the invention and its application. The drawings are intended only to illustrate the invention and they constitute only one of its many possible implementations.

FIG. 1 depicts a person with a climbing harness (100), a standard belay device (200), a carabiner (300) and a rope (400);

FIGS. 2 and 3 depict perspective views of a removable locking mechanism (3);

FIG. 4 depicts a side view of the removable locking mechanism (3);

FIG. 5 is a front view of the quick release auto-blocking belay device (1);

FIG. 6 is a side view of the quick release auto-blocking belay device (1);

FIG. 7 is a back view of the quick release auto-blocking belay device (1);

FIG. 8 is a back cross-sectional view of the device (1);

FIG. 9 is a side cross-sectional view of the device (1);

FIG. 10 is a front cross-sectional view of the device (1);

FIGS. 11 and 12 depict perspective views of main body (2);

FIGS. 13A, 13B, 13C and 13D are front view, back view, right view and left view of quick release auto-blocking belay device, according to additional embodiments of the present invention;

FIGS. 14A and 14B are 3D views of quick release auto-blocking belay device main body and of the main body with a rope inserted in it, according to embodiments of the present invention;

FIG. 15 is a schematic cross section illustration of quick release auto-blocking belay device, along section line AA in FIG. 13D, according to embodiments of the present invention;

FIGS. 16A and 16B are 3D schematic illustrations of rope control assembly and rope control handle, shown respectively from the side adjacent to the first main wall and the second main wall, according to embodiments of the present invention;

FIGS. 17A and 17B are schematic 3D illustrations of rope control assembly shown from external-side view and from internal-side view respectively, according to some embodiments of the present invention; and

FIG. 18 is a schematic 3D illustration of cam-like inner part according to embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

The main objective of the present invention is to provide a quick release auto-blocking belay device (1) which enables the user to release the rope in the end of the abseiling in a fast and quick manner and also provide an automatic blocking of the rope when the user is hanged on the rope.

The quick release auto-blocking belay device (1) includes a main body (2) and a removable locking mechanism (3). The main body (2) has a front wall (21), a back wall (22) and a compartment (23) between them. The main body (2) also includes a connecting hole (24). The front wall (21) includes an entry hole (26) and the back wall (22) includes an exit hole (25). The front wall and the back wall may also include secondary holes (26).

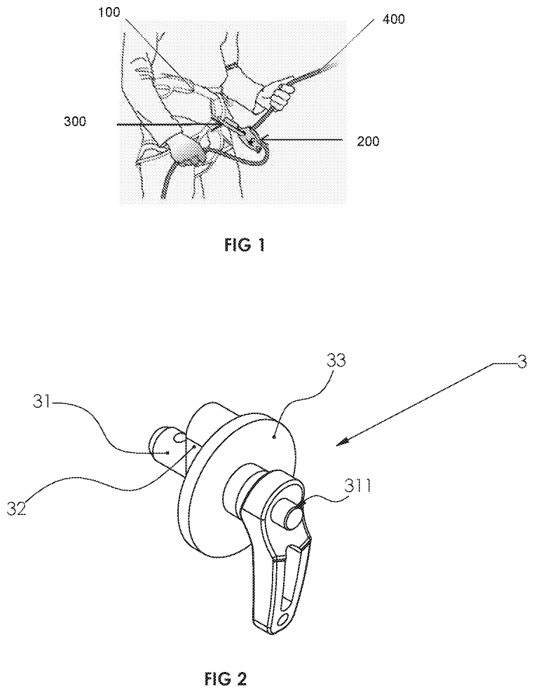

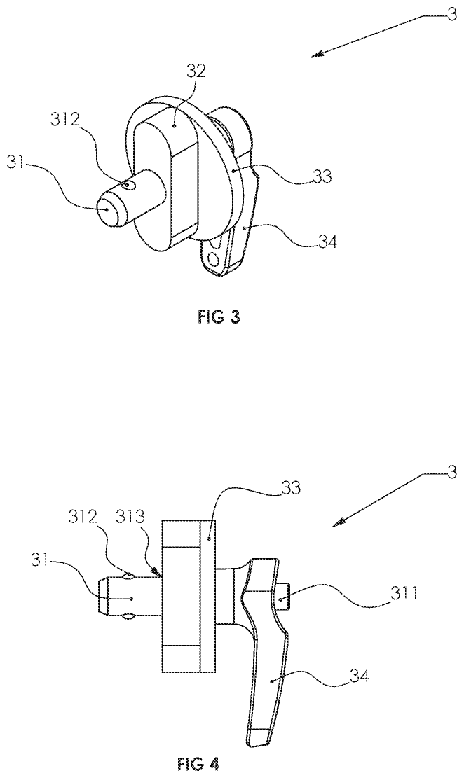

The removable locking mechanism (3) includes a ball lock pin (31), a cam rotating piece (32), a fixing disk (33) and a releasing lever (34). The ball lock pin (31) has a push button at its first end (311) and locking balls at its second end (312). The releasing lever (34) is connected to the ball lock pin (31) at the push button (311) first end part and the cam rotating piece (32) is connected to the center part (313) of the ball lock pin (31). The fixing disk (33) is connected to the ball lock pin (31) between the releasing lever (34) and the cam rotating piece (32). FIGS. 2 and 3 depict perspective views of the removable locking mechanism (3) and FIG. 4 depicts a side view of this mechanism (3).

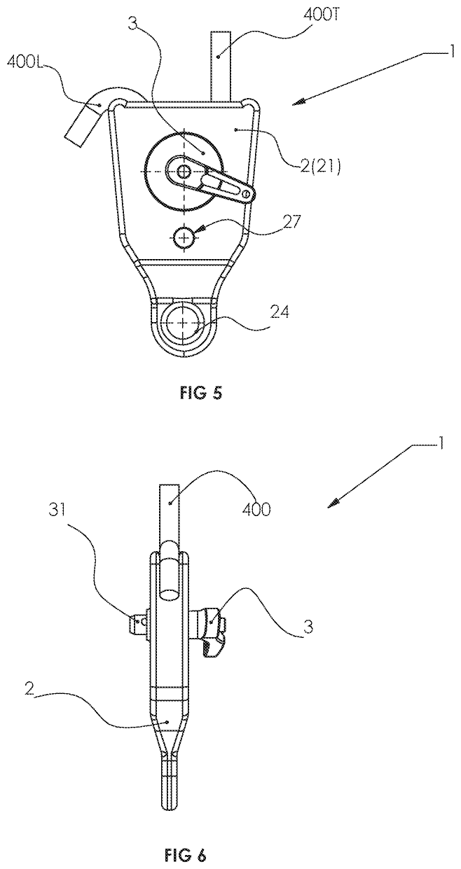

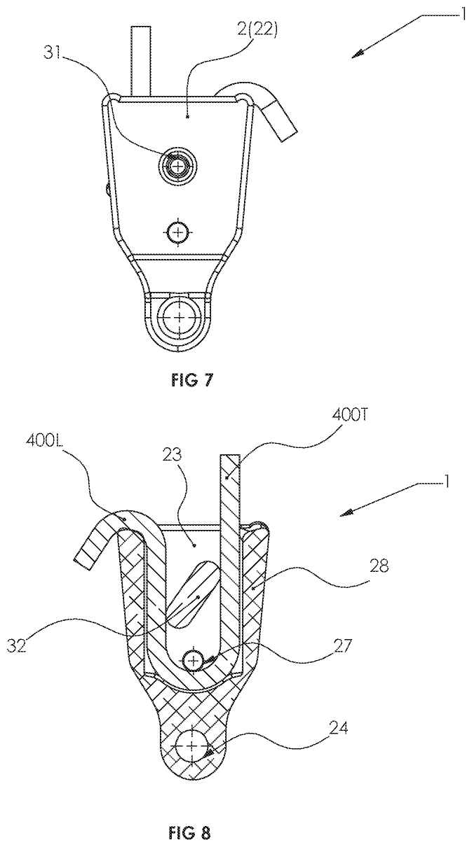

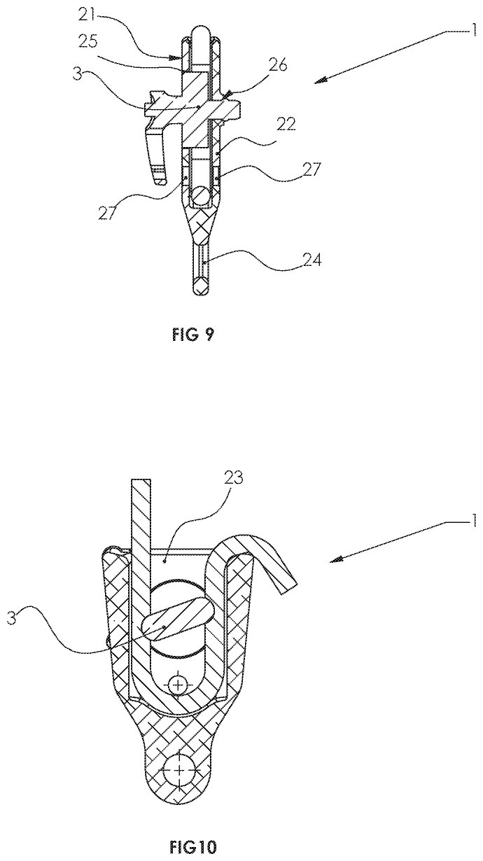

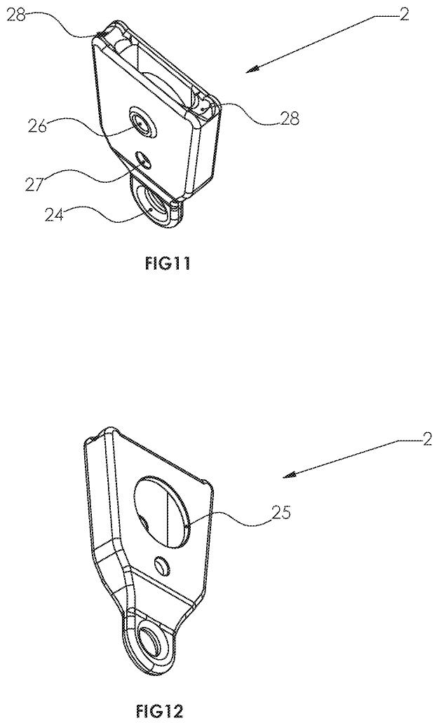

FIG. 5 is a front view of the quick release auto-blocking belay device (1), FIG. 6 is a side view of the device (1), FIG. 7 is a back view of the device (1), FIG. 8 is a back cross-sectional view of the device (1), FIG. 9 is a side cross-sectional view of the device (1), and FIG. 10 is a front cross-sectional view of the device (1). FIGS. 11 and 12 depict perspective views of main body (2).

Assembling the quick release auto-blocking belay device (1): The removable locking mechanism (3) is designed to be inserted into the entry hole (25) and the exit hole (26) to a position in which the locking balls (312) of the ball lock pin (31) are locked in outside the exit hole (26) and the fixing disc (33) is fixed in the entry hole (25) as it is shown for example in FIG. 9.

Preparing the quick release auto-blocking belay device (1) for abseiling: the user inserts the rope in a loop manner inside the compartment (23) and then inserts the removable locking mechanism (3) into the main body (2), as it is explained above and shown in FIGS. 8 and 10. Now the cam rotating piece (32) is located inside the compartment (23) between the front and the back walls (21) (22) and the rope is in a state that it encircles the cam rotating piece (32) inside the compartment (23). The user then can connect the carabiner to the connecting hole (24), to connect the carabiner to the harness and start abseiling.

Using and operating the quick release auto-blocking belay device (1): when the user is abseiling down the tight part of the rope (400T) that is tied to an anchoring point above causes the cam rotating piece (32) to rotate and consequently the cam (32) exercises force on the rope. In this situation the rope is locked between the cam (32) and the side wall (28) of the main body (2) as it is shown for example in FIG. 10. When the user wishes to descends he rotates the releasing lever (34) and consequently the cam (32) rotates to the position that is shown in FIG. 8, and the user can then release the part of the rope that he holds (400L) and abseils. When the user releases the lever (34) the rope rotates the cam (32) back to the locking position, and so forth. That is why the device (1) is in fact an auto-blocking belay device.

Release the rope in the end of abseiling: from the above description it is understood that the hanging point of the rope is on the removable locking mechanism (3) and not on the carabiner as the standard method. When the user ends the abseiling he just needs to press on the push button (311) and to pull out the ball lock pin (31) from the main body (2) to be released from the rope.

The quick release auto-blocking belay device (1) has several advantages. The first one, as described above, is to enables the user to releases himself from the rope instantly at the end of the abseiling. Secondly, when abseiling according the standard method with a non-locking belay device, the user constantly needs to hold the loos part of the rope (400L), even when he is hanged in the air, otherwise the rope will be released and the user will fall down. However, when the user is hanged in the air while using the quick release auto-blocking belay device (1) he does not need to hold the loos part of the rope (400L), due to the fact that the rope is locked, and the user has his hands free for exercising his missions. In addition, it is possible to insert a standard ball lock pin through the secondary holes (27) and to encircle the rope on it for cases a person wishes to lower down another person.

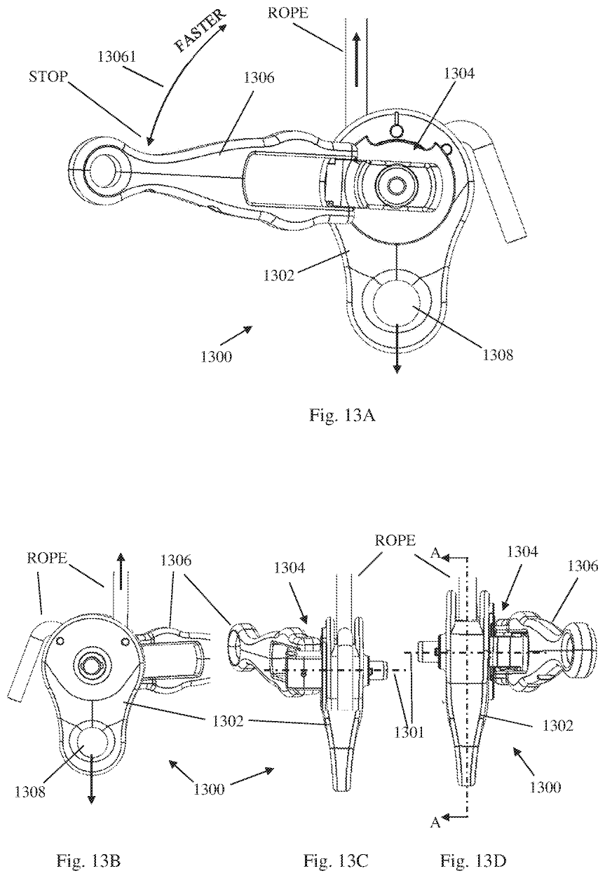

Reference is made now to FIGS. 13A, 13B, 13C and 13D, which are front view, back view, right view and left view of quick release auto-blocking belay (QRABB) device 1300, according to additional embodiments of the present invention. QRABB device 1300 comprises main body 1302, rope control assembly 1304, rope control handle 1306 and load connecting bore 1308. QRABB device 1302 is adapted to have a rope threaded through it so that the rate/speed of movement/sliding of the rope through QRABB device 1300, when the rope is held through its upper edge ROPE-UP and QRABB device 1300 is pulled through connecting bore 1308 to an opposite direction, is controllable by setting the rotation angle of handle 1306 between a full-stop position and free-running position, as indicated by arrow 13061. The control of the speed of sliding of a rope through QRABB device 1300 is controllable by applying changeable friction to the rope inside main body 1302 by means of changing the rotation angle of rope control assembly 1304, for example by means of changing the angle of rotation of handle 1306 about pivot axis 1301, as explained in detail herein below.

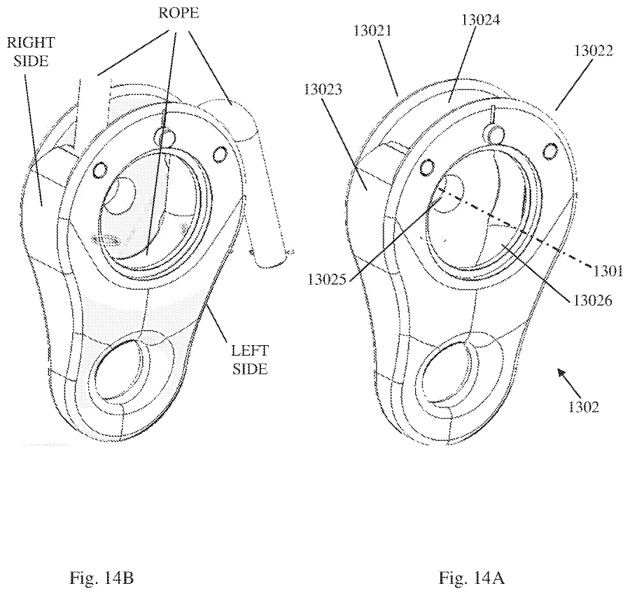

Reference is made now to FIGS. 14A and 14B, which are 3D views of QRABB main body 1302 and QRABB main body 1302 with a rope inserted in it, according to embodiments of the present invention. Main body 1302 may be formed as a hollow housing adapted to accommodate a rope threaded through it and around a central part of rope control assembly 1304 so that the rope may slide through the main body in two directions where the speed of threading may be controlled by the rope control assembly 1304. Accordingly, main body 1302 may have at least one rope opening 13024 confined, according to some embodiments, between first main wall 13022, second main wall 13022 and at least right-side wall and left side wall. First and second main walls 13021 and 13022 may have their faces facing each-other flat and parallel and space apart by a distance that substantially equal to the diameter of the rope to be used with QRABB device 1300. Thereby, first and second main walls 13021 and 13022 define an inner space through which the rope may slide with minimal friction. A first round hole 13025 may be made in first main wall 13021 and a second round hole 13026 may be made in second main wall 130222. First and second round holes 13025 and 13026 may share a common central axis 1301. QRABB main body 1302 may have formed in it load connecting means made preferably at an end of QRABB main body 1302 that is distal from the place ROPE-UP in main body 1032 where the rope is pulled or held by an anchoring means (not shown). The load connecting means may be formed as a load-ready connection hole 1308, formed to allow a load to be attached, connected, harnessed and the like, to QRABB main body 1302.

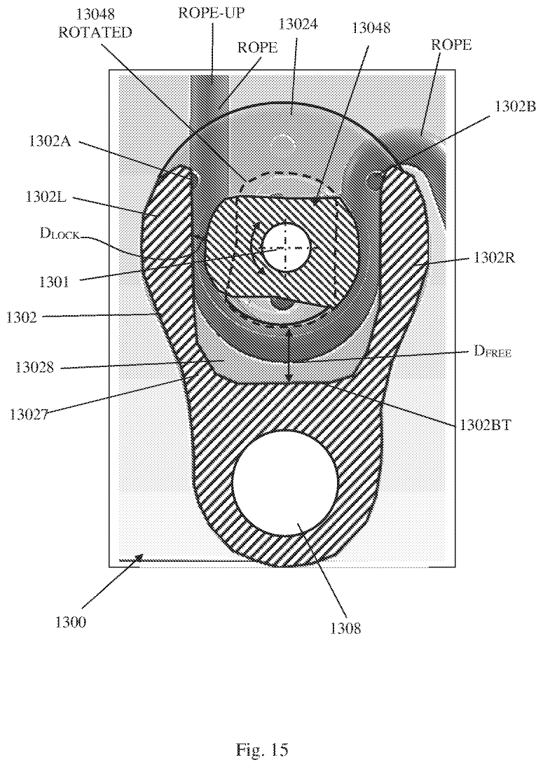

Reference is made now to FIG. 15, which is a schematic cross section illustration of QRABB 1300, along section line AA in FIG. 13D, according to embodiments of the present invention. As seen, the part of QRABB main body 1302 formed between the first and second main walls 13021 and 13022 may form two prong teeth-like elements 1302L and 1302R, defining an empty space around axis 1301. This space is designed so that when a cam-like inner part 13048 of rope control assembly 1304 is inserted and shares the axis of turn 1301 with main body 1302, the distance D_{LOCK} formed between the circumference of cam-like inner part 13048 and teeth-like element 1302R is smaller than the diameter of the rope. Between prong-teeth like elements 1302L and 1302R inner space 13024 may be confined by wall 1302BT. The distance D_{FREE} formed between the circumference of inner cam-like part 13048 when in its rotated position (marked by dashed line) and wall 1302BT is larger than the diameter of the rope, thus ensuring that when rope control cam-like inner part 13048 is in “rotated position” only very little friction is caused between the rope and main body 1302 inner space dur to its sliding through. It shall be apparent to those skilled in the art that the exact distances D_{FREE} and D_{LOCK} may be set to meet the required friction for specific rope diameter and specific rope material and type. Further it will be noted that the design of the roundness of the inner walls of main body 1302 and the outer circumference of cam-line inner part 13048 may also be designed so that the friction of the QRABB device 1300 with the rope, through the entire dynamic operation range of the device is in a desired range.

Main body 1302 may further comprise, disposed between first and second main walls 13021 and 13022, support pins 1302A and 1302B. Pins 1302A and 1302B may provide further structural support for main walls 13021 and 13022. Pin 1302B may also provide rounded turning support for the rope, which may ease the sliding of the rope in or out from QRABB device 1300 and may further provide enhanced control of the rate of sliding of the rope through QRABB device 1300, while enabling easier and cheaper maintenance of worn out pins (dur to over wear by the rope) simply by replacement of the pins.

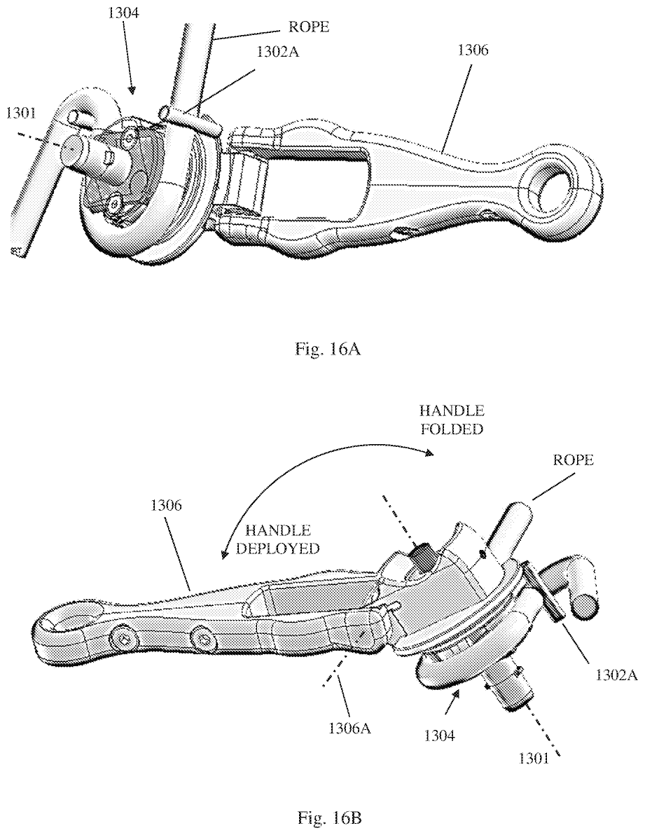

The operation of rope control mechanism is exclaimed in detail below. Reference is made now to FIGS. 16A and 16B, which are 3D schematic illustrations of rope control assembly 1304 and rope control handle 1306, shown respectively from the side adjacent to the first main wall and the second main wall, according to embodiments of the present invention. Rope control assembly 1304 is formed to be rotatable within main body 1302 around common axis 1301 when installed in QRABB device 1300. Rope control handle 1306 is made to enable rotation of rope control assembly around axis 1301. According to some embodiments rope control handle may be foldable/deployable around its fold/deploy axis 1306A between folded position and deployed position allowing easy operation and extended moment about axis 1301. In some embodiments handle 1306 may be spring-returned to its folded position. It will be apparent that that some other or additional embodiments the handle may be retracted or extracted by different design(s). Rope control handle 1036 is axially connected to rope control assembly 1304 via handle fold/deploy pivot 1306B.

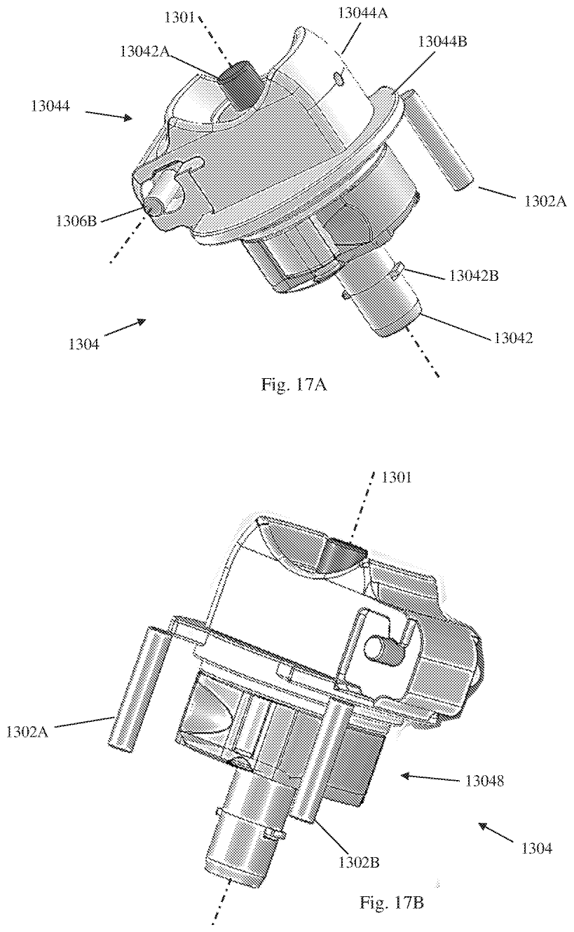

Reference is made now to FIGS. 17A and 17B, which are schematic 3D illustrations of rope control assembly (RCA) 1304, shown from external-side view and from internal-side view respectively, according to some embodiments of the present invention. Rope control assembly 1304 may comprise external unit 13044A connected to, or made in one unit with RCA external disk 13044B. RCA 1304 further comprise cam-like inner part 13048 made as one unit or firmly attached to RCA external unit 13044A and RCA external disk 13044B, thereby concurrently rotatable with them. RCA 1304 further comprise central shaft-pin 13042 made along central axis 1301 of RCA 1304. Central shaft-pin 13042 may be formed with quick release mechanism adapted to enable, by pressing release knob 13042A, unlocking lock teeth 13042B, thereby enabling pulling RCA 1304 out of main body 1302 or insertion of RCA 1304 into main body 1302. The external diameter of external disk 13044B may be designed to smoothly fit within second hole 13026 and the outer diameter of shaft/pin 13042 may be designed to smoothly fit within first hole 13025. Accordingly, when RCA 1304 is inserted into main body 1302, RCA 1304 is adapted to freely and accurately rotate about common axis 1301 within main body 1302. The location of lock teeth 13042B along shaft/pin 13042 is designed so that when RCA 1304 is properly inserted into main body 1302 teeth 13042B protrude from shaft/pin 13042 close to the outer face of first wall 13021 of main body 1302. When knob 13042A is not pressed teeth 13042B protrude from shaft/pin 13042 thereby prevent complete insertion of RCA 1304 into main body 1302 or prevents taking it out of main body 1302, respectively. When knob 13042A is pressed against a return spring, insertion into, or taking RCA 1304 out of main body 1302 is enabled.

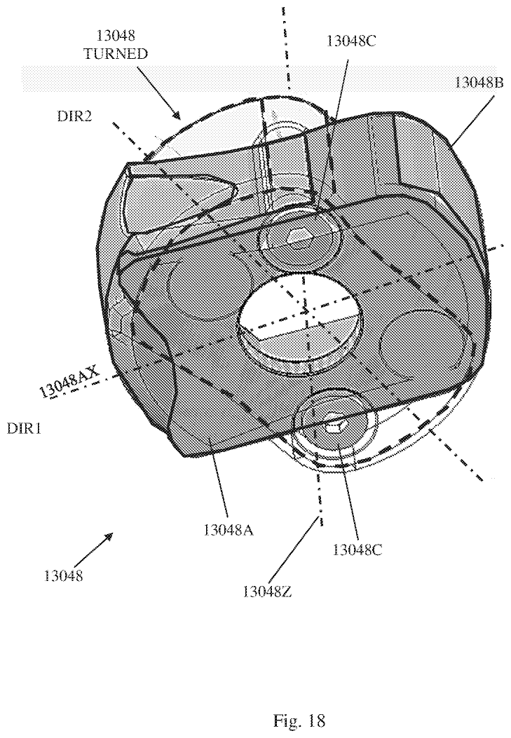

Reference is made now to FIG. 18, which is a schematic 3D illustration of cam-like inner part (CLIP) 13048 according to embodiments of the present invention. CLIP 13048 may be formed as a cam, so that when rotated about its rotation axis 1301 the distance formed between its external circumference and inner walls of main body 1302 is changed with the change of the angle of rotation, as discussed above. CLIP 13048 has an elongated shape with longitudinal axis 13048AX. By way of rotating of RCA 1304 CLIP 13048 may be rotated between first rotation end DIR1 and second rotation end DIR2. According to some embodiments DIR1 may correspond to rotation angle that provides maximum friction/locking position to the rope while DIR2 may correspond to rotation angle that provides minimal friction to the rope. Accordingly, when RCA 1304 is set to DIR1, for example by way of operating handle 1306, QRABB device 1300 provides maximal friction/full stoppage to the rope Similarly when RCA 1302 is set to DIR2, for example by way of operating handle 1306, QRABB device 1300 provides minimal friction to the rope. Thereby, when the upper edge of the rope is anchored to a fixed position and load hangs from connection hole 1308, exerting force opposite to the force provided by the upper rope, when RCA 1304 is set to DIR1 the rope may be locked thereby preventing QRABB 1300 with the load hanging from it to slide down the rope. When the rotation angle of CLIP 13048 is changed from DIR1, the rope is unlocked and the amount of friction that is provided to the rope by QRABB device 1300 is controllable by means of setting the rotation angle of handle 1306.

According to some embodiments, CLIP 13048 may be made from two different materials. For example, in order to provide good and durable friction contact with the rope the outer face portion of CLIP 13048 may be made of a hard and durable material, e.g. stainless steel. In order to keep the total weight of CLIP 13048 as low as possible it is possible to produce inner portions of CLIP 13048 from a material lighter than that of the outer face of CLIP 13048. For example, CLIP 13048 may be produced from a combination of stainless steel at the outer face and aluminum in its inner body.

According to some embodiments QRABB device 1300 provides default self-block feature. As may be seen in FIG. 15, when no manual force is exerted onto RCA 1304, the tendency of a load hanging from QRABB 1300 to full QRABB device 130 along the rope will cause the rope to rotate CLIP 13048 with it as it slides through QRABB device 1300 due to friction of the rope with CLIP 13048. The rotation of CLIP 13048 with the rope sliding over it will eventually bring CLIP 13048 to lock position, e.g. DIR1.

When it is required to remove QRABB device 1300 from the rope, remove the rope from

QRABB device 1300, or otherwise departing QRABB device 1300 from the rope—without having to unthread the rope along its full length, RCA 1304 may be unlocked by pressing knob 13042A and then be pulled out of main body 1302, leaving the rope that is inside main body 1302 free to be pulled out. I a similar manner, when it is required to insert the rope into QRABB device 1300 without having to thread it along its entire length, RCA 1304 may be released from main body 1302 by pressing knob 13042A and pulling RCA 1304 out, then the rope may be easily inserted into main body 1302 so that the rope forms a half circle inside the main body, while leaving enough free space for the RCA 1304 to be inserted into main body 1302, and be locked in place by releasing knob 13042A.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A quick release auto-blocking belay device (1300) comprising:
a main body (1302);
a rope control assembly (1304) comprising;
an external unit (13044A);
a disk element (13044B);
a shaft; and
a cam-like inner part (13048);
wherein the external unit, the disk element, the cam-like inner part and the shaft are connected together to rotate as one piece, and
wherein the rope control assembly is adapted to fit into a first hole made in a first wall of the main body and into a second hole made in a second wall of the main body, to be locked after insertion and to rotate about a common axis passing longitudinally through the shaft,
a rope control handle (1306) connected to the rope control assembly; and
a load hanging means,
wherein the rope control assembly is adapted be locked in the main body or to be released from the main body by pressing a release knob.

2. The device of claim 1 wherein the cam-like inner part is adapted to provide auto blocking force onto a rope threaded through the main body and around the cam-like inner part, when no manual rotation force is provided to the rope control assembly.

3. A method of operating a quick release auto-blocking belay device, comprising:
(i) when preparing to begin use of the quick release auto-blocking belay device:
providing a quick release auto-blocking belay device, the device comprising:
a main body (1302);
a rope control assembly (1304) comprising;
an external unit (13044A);
a disk element (13044B);
a shaft with a release knob; and
a cam-like inner part (13048);
a rope control handle (1306) connected to the rope control assembly; and
a load hanging means;
pressing the release knob on the shaft;
pulling the rope control assembly out from the main body;
inserting a rope into a rope space in the main body and leaving a space for insertion of the rope control assembly;
inserting the rope control assembly into the main body;
locking the rope control assembly by releasing the knob;
(ii) when finishing use of the quick release auto-blocking belay device:
pressing the release knob on the shaft;
pulling the rope control assembly out from the main body;
pulling the rope out of the main body; and
inserting the rope control assembly into the main body.

4. The method of claim 3, further comprising, at the end of stage (i):
controlling the speed of threading of the rope through the main body by changing the relative rotation angle of the rope control assembly with respect to the main body, by means of rotating the rope control handle.

5. The method of claim 4, further comprising, during the use of the quick release auto-blocking belay device:
allowing the cam-like inner part to lock the rope in the main body and prevent it from being pulled out, when the rope control handle is not set to enable threading of the rope through the main body.
